(19) United States
(12) Patent Application Publication
(10) Pub. No.: US 2010/0125514 A1
(43) Pub. Date: May 20, 2010

(54) Least Cost Routing of Fund Transfer Transactions

(75) Inventors: Jason P. Blackhurst, Charlotte, NC (US); Anthony B. Calderone, Charlotte, NC (US); William E. Thomas, Charlotte, NC (US)

Correspondence Address: BANNER & WITCOFF, LTD;ATTORNEYS FOR CLIENT NUMBER 007131, 10 SOUTH WACKER DR., SUITE 3000, CHICAGO, IL, 60606, US

(73) Assignee: Bank of America Corporation, Charlotte, NC (US)

(21) Appl. No.: 12/271,833

(22) Filed: Nov. 14, 2008

(51) Int. Cl. G06Q 40/00

(52) U.S. Cl. 705/35

(57) ABSTRACT

Aspects of the disclosure relate to enhancing the transfer of funds involving particular payee-payors. Users sometimes desire to remotely transfer funds from their account (i.e., payor account) to a payee, but are ambivalent as to the delivery mechanism their financial institution uses to perform the transfer. Systems and methods are disclosed that relate to using a routing engine to assist in transferring funds in an enhanced manner.

### TECHNICAL FIELD

Aspects of the disclosure relate to enhancing the transfer of funds. More specifically, aspects of the disclosure relate to enhancing fund transfer transactions involving particular payee-payors.

### BACKGROUND

Online bill payment, ACH (automated clearing house) transfers, wire transfers, direct deposits, and other technologies for transferring funds are widely used in the banking industry. For example, a user can configure her account to transfer funds on a one-time basis or on a recurring basis. For example, numerous websites provide the ability to login to one's account and make a payment using a credit card, debit card, electronic check (i.e., providing a bank routing number and bank account number, or other payment means). In other instances, a user can configure a website for recurring payments (e.g., on a quarterly, monthly, or annual basis) using the user's preferred method of payment.

In the example of online bill payment, a financial institution's website provides a user the ability to login to the user's account and designate/select one or more payees for recurring payments. Then, the financial institution acts on behalf of the user to automatically pay the user's bills from the payee on a recurring basis. For example, in the case of a utility company, the user receives a monthly bill from the utility company. The financial institution also receives electronic bill information from the utility company and automatically pays the outstanding balance on or before its due date. In another example, a financial institution may provide its checking account holders with the ability to pay outstanding credit card balances they hold with the financial institution or its subsidiaries using the financial institution's website. The financial institution's website may submit the payment request to the financial institution's back-end payment processing system with the requisite information the system needs to process the payment. This requisite information may include whether to the system should use ACH transfer, or other payment technologies to transfer the payment amount.

In another example, the user configures the online bill payment feature to allow/require the user to manually authorize the payment of each bill. In such a case, the financial institution receives electronic bill information from the utility company and prepares the information for the user's review and authorization. The user then reviews each item before authorizing payment by clicking a “submit” button on the webpage.

After receiving authorization to submit payments, the financial institution uses a predetermined method for transferring the funds. Current government regulations require the financial institution to perform some verification on any funds leaving the financial institution. For example, the office of foreign accounting controls (OFAC) may require an audit of any funds entering or leaving the financial institution. Other regulations aimed at anti-money laundering (AML) protection may require the financial institution to perform additional auditing. As such, the financial institution may incur costs associated with performing such audits. However, many financial institutions charge their users little to nothing for online bill payment.

Additional costs may be incurred in using the ACH electronic network for transferring funds. The Electronic Payments Association (formerly the National Automated Clearing House Association, i.e., NACHA) promulgates rules and regulations governing ACH networks. In common ACH transactions involving fund transfers, an originating depository financial institution (ODFI) sends an ACH entry to an operator (e.g., the Federal Reserve) to be passed on to a receiving depository financial institution (RDFI) where the payee's account may be issued a credit. Fees and inefficiencies may be incurred in this process.

Numerous financial institutions use a third-party intermediary to transfer funds (e.g., to provide bill payment and/or presentment services). The third-party intermediary routes the funds from the source (i.e., the financial institution of the user paying a bill) to the recipient (i.e., the financial institution where the utility company holds an account). The third-part intermediary assumes the responsibility of maintaining the recipient's preferred method of receiving payments and other related information. For example, some recipients may require that funds are deposited via ACH transfer into a designated account at their designated financial institution. Other recipients may require that funds are mailed in paper check form with accompanying payment coupons to a designated post office box address for processing. The third-party intermediary may charge a per-transaction fee. As a result, in addition to the costs associated with regulatory compliance, the financial institution also pays an amount to the third-party intermediary.

Consequently, once the financial institution hands off the funds to a third-party intermediary, the financial institution may not have ready access to information about the status of the requested fund transfer at any given time. As such, the financial institution cannot easily provide its users with information about the location of the user's funds should the user inquire. From at least a customer service perspective, these circumstances are not ideal. A user may become frustrated if the recipient (e.g., the user's utility company) reports that they have not received funds when the user's financial institution's website informs the user that funds have been removed from the user's account.

Therefore, there is a need in the art for methods, apparatuses, and/or systems to enhance electronic fund transfers.

### BRIEF SUMMARY

The following presents a simplified summary of the disclosure in order to provide a basic understanding of some aspects. It is not intended to identify key or critical elements of the invention or to delineate the scope of the invention. The following summary merely presents some concepts of the disclosure in a simplified form as a prelude to the more detailed description provided below.

Aspects of the invention relate to methods for enhancing efficiency and operation of fund transfer transaction processing. In one embodiment, upon receiving a request to transfer funds to a payee, a financial institution may use a computing device to select a delivery mechanism from numerous options of delivery mechanisms. In one embodiment, the delivery mechanisms may include wired funds transfer service, automated clearing houses transfer (“ACH”) network, electronic check service (i.e., paper check with postal delivery), third-party intermediary, and/or other fund transfer technology available in the banking industry. A data store (storing a customer-payee collection) may be accessed to determine whether to select one of the plurality of delivery mechanisms or to perform an internal electronic transfer.

In yet another embodiment in accordance with aspects of the disclosure a computer-readable medium is disclosed that stores computer-executable instructions which cause a processor to perform one or more of the aforementioned methods and features.

### BRIEF DESCRIPTION OF THE DRAWINGS

The present disclosure is illustrated by way of example and not limited in the accompanying figures in which like reference numerals indicate similar elements and in which:

FIG. 1 illustrates a schematic diagram of a general-purpose digital computing environment in which various aspects of the disclosure may be implemented;

FIG. 2 illustrates one example of an bill payment review graphical user interface in accordance with various aspects of the disclosure; and

FIG. 3 is a flowchart of an exemplary method of routing fund transfer transactions in accordance with one embodiment of the invention.

### DETAILED DESCRIPTION

In accordance with various aspects of the disclosure, systems, apparatuses, and methods are illustrated for enhancing the transfer of funds.

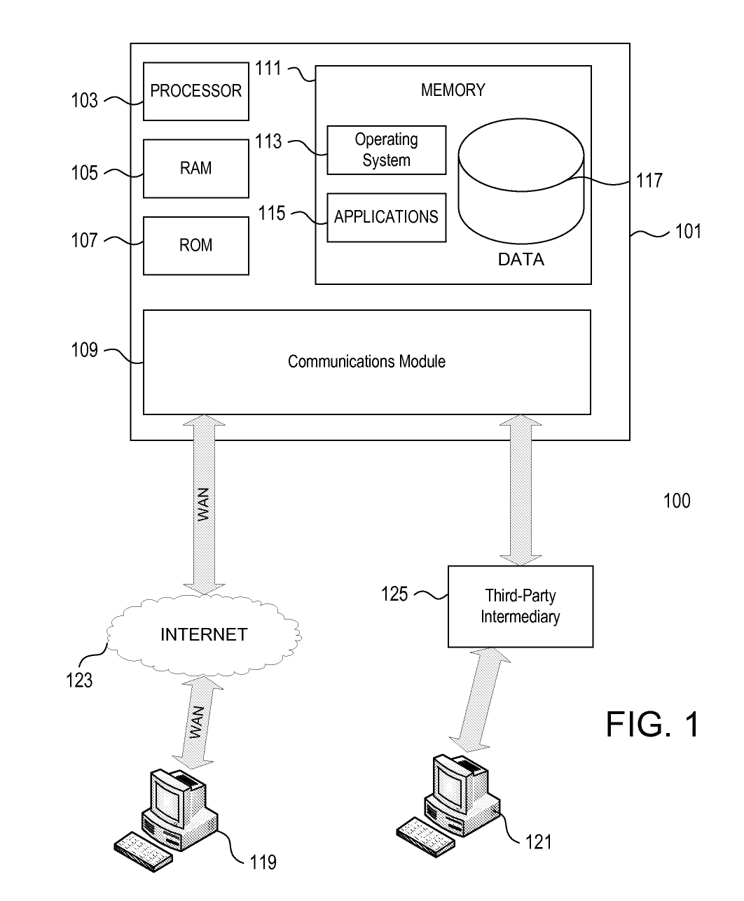

FIG. 1 illustrates an example of a suitable computing system environment 100 that may be used according to one or more illustrative embodiments of the disclosure. The computing system environment 100 is only one example of a suitable computing environment and is not intended to suggest any limitation as to the scope of use or functionality of the disclosure. The computing system environment 100 should not be interpreted as having any dependency or requirement relating to any one or combination of components illustrated in the illustrative computing system environment 100.

The disclosure is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

With reference to FIG. 1, the computing system environment 100 may include a computing device 101 having a processor 103 for controlling overall operation of the computing device 101 and its associated components, including RAM 105, ROM 107, communications module 109, and memory 111. Computing device 101 typically includes a variety of computer readable media. Computer readable media may be any available media that may be accessed by computing device 101 and include both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, random access memory (RAM), read only memory (ROM), electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and that can be accessed by computing device 101.

Communication media typically embodies computer readable instructions, data structures, program modules or other data in a modulated data signal such as a carrier wave or other transport mechanism and includes any information delivery media. Modulated data signal is a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media. Although not shown, RAM 105 may include one or more are applications representing the application data stored in RAM memory 105 while the computing device is on and corresponding software applications (e.g., software tasks), are running on the computing device 101.

Communications module 109 may include a microphone, keypad, touch screen, and/or stylus through which a user of computing device 101 may provide input, and may also include one or more of a speaker for providing audio output and a video display device for providing textual, audiovisual and/or graphical output. In other embodiments, communications module 109 may comprise a modem, network interface or adapter, or other means (e.g., Ethernet circuitry, wireless circuitry, etc.) for establishing communications over the Internet 123 and/or other networks.

Software may be stored within memory 111 and/or storage to provide instructions to processor 103 for enabling computing device 101 to perform various functions. For example, memory 111 may store software used by the computing device 101, such as an operating system 113, application programs 115, and an associated data store 117. Alternatively, some or all of the computer executable instructions for computing device 101 may be embodied in hardware or firmware (not shown). As described in detail below, the data store 117 may provide centralized storage of account information and account holder information for the entire entity, allowing interoperability between different elements of the entity residing at different physical locations.

The disclosure may be described in the general context of computer-executable instructions, such as program modules, being executed by a computing device 101. Generally, program modules include routines, programs, objects, components, data structures, etc. that perform particular tasks or implement particular abstract data types. The disclosure may also be practiced in distributed computing environments where tasks are performed by remote processing devices that are linked through a communications network. In a distributed computing environment, program modules may be located in both local and remote computer storage media including memory storage devices. For example, in FIG. 1, the function of the components illustrated for computing device 101 may be distributed across multiple machines such that, for example, some of the data store 117 may be stored in a separate physical machine and accessed by computing device 101 over a network.

Computing device 101 may operate in a networked environment supporting connections to one or more remote computing devices, such as user workstation 119 and payee computer system 121. The user workstation 119 may be a personal computing device or server that includes many or all of the elements described above relative to the computing device 101. The network connections depicted in FIG. 1 include a wide area network (WAN), such as the Internet 123, but may also include other networks. When used in a LAN networking environment, computing device 101 is connected to the LAN through a network interface or adapter in the communications module 109. When used in a WAN networking environment, the computing device 101 may include a modem in the communications module 109 or other means (e.g., Ethernet circuitry, wireless circuitry, etc.) for establishing communications over the Internet 123. It will be appreciated that the network connections shown are illustrative and other means of establishing a communications link between the computing devices may be used. The existence of any of various well-known protocols such as TCP/IP, Ethernet, FTP, HTTP and the like is presumed, and the system can be operated in a client-server configuration (e.g., with a thin client, fat client, or browser-based client) to permit a user to retrieve web pages (or information in another format) from a web-based (or non-web-based) server. Any of various conventional web browsers can be used to display and manipulate data on web pages. In one example, the communication between a user workstation 119 and the computing device 101 may be facilitated by one or more web servers, application servers, or other machines.

The payee computer system 121 may be operated by a financial institution used by a payee (e.g., a utility company), which in some cases may be different from the payor's financial institutions. The payor's financial institution may communicate with the payee's financial institution through a third-party intermediary 125. The third-party intermediary routes the funds from the user's financial institution to the payee's financial institution. The third-party intermediary may charge a per-transaction fee. As a result, in addition to the costs associated with regulatory compliance, the financial institution may also pay an amount to the third-party intermediary. For example, some payees may require that funds are deposited into a designated account at their designated financial institution via ACH transfer. Other payees may require that funds are mailed in paper check form to a designated post office box address for processing. In prior art online bill pay systems, payments submitted by a payor were automatically routed through a third-party intermediary without consideration for the identity of the payee and the payee's financial institution. In fact, the payor and the payor's financial institution were not necessarily made aware of the payee's financial institution. Rather, the third-party intermediary maintained the requisite data to identify the payee's financial institution and route the funds accordingly.

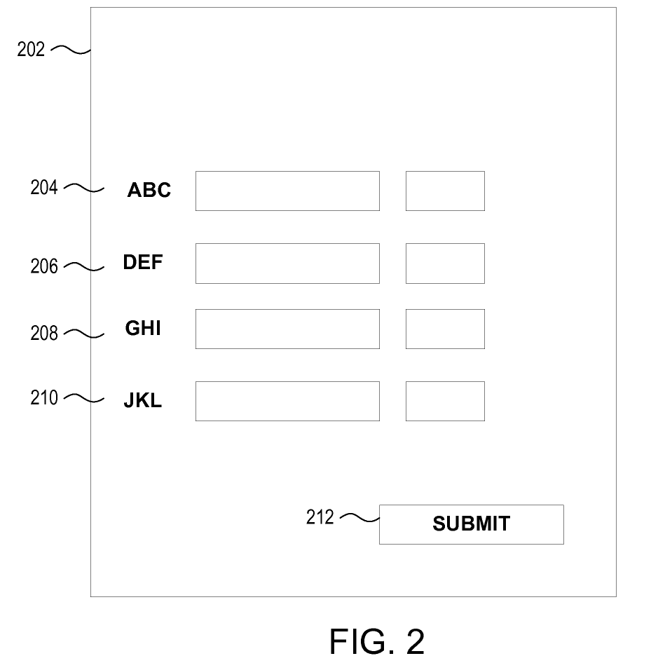

FIG. 2 illustrates an exemplary graphical user interface 202 displayed to a user to allow the user to select and authorize fund transfers to multiple payees ABC 204, DEF 206, GHI 208, JKL 210. The name/identification of each payee, the quantity of funds being to be transferred on a particular date, and the payor's account number designated by the payee (e.g., the account number a payee utility company has assigned to a payor) may be displayed/entered on the graphical user interface 202. A “submit” button 212 may also be provided to allow the user to authorize payment once he/she has finished reviewing the transfers listed on the graphical user interface 202.

In FIG. 2, when the user presses the “submit” button 212, a corresponding remote server (e.g., a web server, load balancer, etc.) may communicate (either directly or indirectly) with a computing device 101 implemented in accordance with various aspects of the disclosure. In one example, the remote server may communicate with one or more application servers, such as computing device 101. In another example, computing device 101 may include a remote server in addition to implementing one or more aspects of the disclosure.

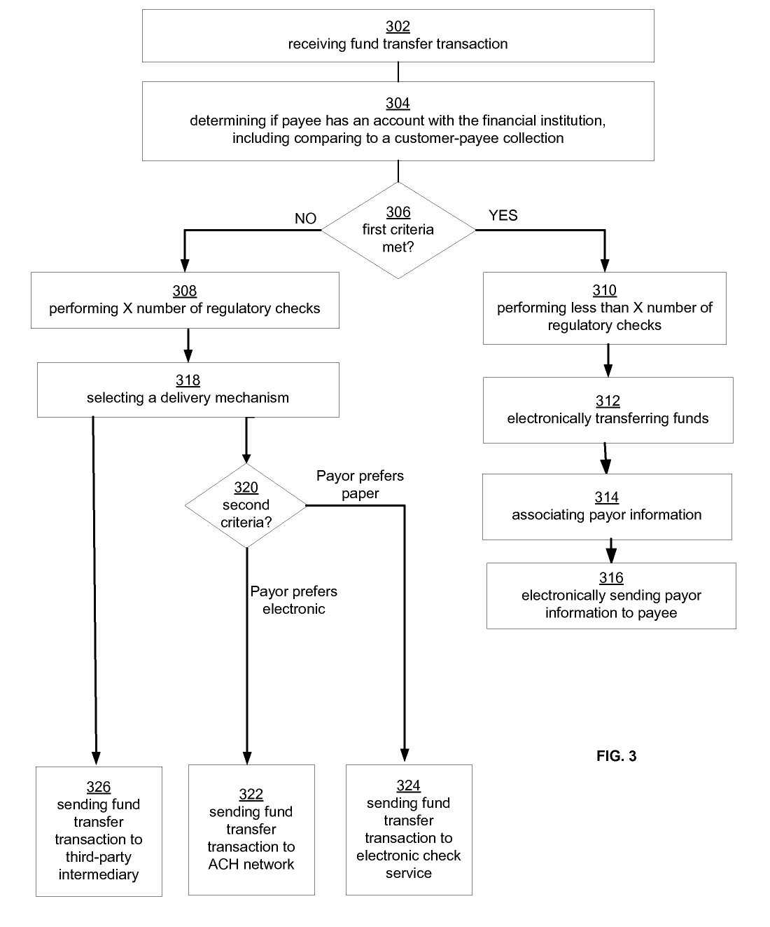

FIG. 3 is a flowchart of an exemplary method of routing fund transfer transactions in accordance with one embodiment of the invention. By way of example, FIG. 3 is described in conjunction with the various components in FIG. 1. However, one skilled in the art will appreciate that the performance of steps described in FIG. 3 does not necessarily require each and every component illustrated in FIG. 1.

In step 302, a fund transfer transaction (hereinafter “FTT”) is received at a computer network at a financial institution. The computer network may comprise of one or more computers (e.g., web servers, application servers, database servers, etc.), network devices (e.g., load balancers, firewalls, etc.), or other devices well known to those of skill in the art. The FTT may be sent from a remote user (e.g., payor) on a financial institution's website using an online bill pay feature that directs the transmittal of funds. Specifically, the funds are to be transmitted from the payor's account to a payee (e.g., a utility company). In another example, the payor may have setup automatic recurring payments to a payee (e.g., electric company) using a financial institution's online bill pay software. In yet another example, the FTT may be sent from a payor requesting a one-time transfer of funds to a payee on a particular date (e.g., a roommate using an electronic check service to pay his roommates for his share of the groceries.) In another example, the FTT may be sent by a bank teller (or kiosk) requesting a fund transfer on behalf of a customer at a retail location. In yet another example, the payor may be an employer desiring to perform a monthly direct deposit of its employee's salary (or other compensation or reimbursement) into the bank account of the payee (i.e., employee).

The FTT received at computing device 101 may include, but is not limited to, electronic payee information, identification of the payor, amount of funds being transferred from the payor to the payee, the desired date for the transfer, and/or the type of transfer (e.g., delivery mechanism) required. The electronic payee information may be configured to enable identification of the payee in the transfer of funds from the payor's account to the payee. The electronic payee information may include, but is not limited to, the name of the payee, the bank account number of the payee, the ABA routing number of the bank of the payee, and/or any other information useful to identify the payee that would be apparent to one skilled in the art after review of the entirety disclosed herein.

In numerous embodiments in accordance with aspects of the invention, the FTT might not include the type of transfer the payor requires. For example, if a payor simply wants to send money to a payee by a particular date and is ambivalent as to how the funds are actually transferred, the payor may not wish to mandate a particular delivery mechanism for the transfer. In essence, the payor is allowing the computing device 101 at the financial institution to determine the least cost method of routing the FTT. Furthermore, the financial institution's website (e.g., online bill pay feature) might not include any indication of what particular delivery mechanism is to be used when the FTT is submitted and eventually received at computing device 101. Step 320 in FIG. 3, discussed below, further elaborates on embodiments where the payor designates a preference about how the delivery mechanism used to transfer their funds.

In step 304, computing device 101 determines if the payee has an account with the financial institution. In one example, the determination comprises the comparison of the electronic payee information received in the FTT to a customer-payee collection stored in memory 111. The customer-payee collection contains identifiers of customers of the financial institution that have been identified as payees. For example, an electric company may be an account holder at the financial institution, and it may receive frequent payments from its customers. The financial institution may identify the electric company as a customer-payee (i.e., a customer that is the frequent recipient of fund transfers) and add the customer's identifier (e.g., information comparable to the electronic payee information) to the customer-payee collection. In some examples, the customer-payee collection may be stored in a high-speed database server and capable of being queried for matches. In another example, the customer-payee collection may be a flat file storing a list (e.g., linear list, binary tree, etc.) of customer identifiers. In some embodiments in accordance with various aspects of the invention, a customer may request to be added to customer-payee collection. Alternatively, assuming sufficient computing resources are available, every customer may be added to the customer-payee collection.

performing a plurality of regulatory checks, where the plurality of regulatory checks are configured to detect money laundering activity and to comply with rules defined by a plurality of governmental regulations

In step 306, as a result of the comparison in step 304, the computing device 101 determines whether the payor's account and the payee's account are with the financial institution. If the criteria in step 306 is found to be false, per its normal regulatory requirements, the financial institution may be required to perform a number of regulatory checks (in step 308). The plurality of regulatory checks may be configured to detect money laundering activity and to check if the FTT complies with rules defined by a plurality of governmental regulations, such as those promulgated by the office of foreign assets controls (OFAC). For example, OFAC may require an audit of any funds entering or leaving the financial institution. Other regulations aimed at anti-money laundering (AML) protection may require the financial institution to perform additional auditing. In addition a currency transaction report (CTR) may be required for any fund transfer over ten thousand dollars.

However, if the criteria in step 306 is found to be true, the financial institution may be able to perform less regulatory checks (in step 310) than it was required to perform in step 308. For example, if the financial institution regularly verifies its customers against the OFAC's list of suspected terrorists and other lists (e.g., SDN list), an internal fund transfer between two customers of the financial institution may not mandate the same OFAC regulatory check to be performed. As such, at least one advantage of an aspect of the invention is a reduction in cost and time in performing regulatory checks. One or more regulatory checks may be performed in an automated electronic fashion using computers (e.g., application servers, web services, etc.) or a processor 103 at the computing device 101 (e.g., running regulatory check software) at the financial institution. If one or more regulatory checks performed in step 308 or step 310 fail, the FTT may be aborted and a report generated for sending to the appropriate office/department.

In step 312, the funds of the FTT are electronically transferred from the payor's account to the payee's account. Since both the payor and payee are customers of the financial institution, the financial institution is not required to resort to the ACH network for transferring the funds. As such, fees and time delays associated with an ACH transfer are avoided.

In step 314, electronic payor information is associated with the fund transfer transaction. One example of electronic payor information is an account number assigned to the payor by the payee (e.g., a customer's account number with the electric company.) At least one benefit of the associating in step 314 is to enable the payee to identify the payor. For example, there may be many situations where a payee has numerous customers with the same name. Therefore, when a credit appears in a payee's bank account for a particular amount, the payee may not be able to easily identify its customer that made the payment. Therefore, a payee (e.g., utility company) may request that its customers include their assigned account number on any payment. As such, in step 316, the financial institution may electronically send such information (e.g., account number assigned to the payor by the payee) to the payee for each FTT (or in an aggregated monthly electronic statement). Recall from FIG. 2, a payor may enter such information in graphical user interface 202 before hitting the submit button 212; alternatively, the payor may enter such information once and request the financial institution to automatically include it in any subsequent payments to the payee (e.g., in the example of automatically recurring FTTs on a predetermined billing cycle.)

At step 318, a delivery mechanism for transmitting the funds to the payee is selected from a plurality of delivery mechanisms. In one embodiment, at least one of the potential delivery mechanisms that may be selected is operated by third party (i.e., third-party intermediary). As used herein, the term “third-party” refers to any party that is not the financial institution that controls the account from which the funds are to be taken from, therefore, by using such delivery mechanism, the financial institution is not in control of the delivery of the funds. One such example would an electronic bill payment service. Examples of delivery mechanisms include, but are not limited to: wired funds transfer service, ACH network, electronic check service (i.e., paper check with postal delivery), third-party intermediary, and/or other fund transfer technology available in the banking industry.

In some examples, the selecting in step 318 is performed in step 320 based on whether the payor has designated a preference in how the funds should be sent. For example, the payor may mandate that the funds be transferred in paper format (e.g., using an electronic check service) or in electronic format (e.g., using an ACH network). As explained earlier, in some situations a payor may be required to send funds in a particular way. For example, in a situation where a payee does not have a bank account and requires a paper check, the payor may designate a paper format preference. In such a situation, in step 324, the FTT may be sent to an electronic check service that is able to print a paper check and mail it to the payee's address. The payor may be required to enter the full address of the payee in the graphical user interface 202 so the electronic check service can mail the paper check. Such entered information may be additional examples of electronic payee information. In another example, if the payor is required to send funds using an ACH transfer, the payor may designate such a requirement on graphical user interface 202. Accordingly, the financial institution may send the FTT to the ACH network (in step 322) for processing.

In some embodiments in accordance with various aspects of the invention, if the payor does not require a particular delivery mechanism (i.e., no second criteria selection is provided for step 320), the computing device 101 at the financial institution may send the FTT to a third-party intermediary in step 326. Numerous financial institutions use a third-party intermediary to transfer funds (e.g., to provide bill payment and/or presentment services). The third-party intermediary routes the funds from the source (i.e., the financial institution of the user paying a bill) to the recipient (i.e., the financial institution where the utility company holds an account). The third-part intermediary assumes the responsibility of maintaining the recipient's preferred method of receiving payments and other related information. As explained earlier, the third-party intermediary has an established relationship with payees and processes the FTT per the payee's instructions. However, the third-party intermediary may charge a per-transaction fee. As a result, in addition to the costs associated with regulatory compliance, the financial institution also pays an amount to the third-party intermediary.

Although current regulations formally prohibit US financial institutions from using their electronic bill payment systems for payments to tax authorities, collection agencies, or recipients of court-ordered payments like child support or alimony, one skilled in the art will appreciate that if such regulations should change, the disclosure contemplates such embodiments. The same also applies to transactions involving any organizations or individuals outside of the United States, which is also usually excluded.

Although not required, one of ordinary skill in the art will appreciate that various aspects described herein may be embodied as a method, a data processing system, or as a computer-readable medium storing computer-executable instructions. Aspects of the invention have been described in terms of illustrative embodiments thereof. Numerous other embodiments, modifications and variations within the scope and spirit of the appended claims will occur to persons of ordinary skill in the art from a review of this disclosure. For example, one of ordinary skill in the art will appreciate that computing device 101 may be a server machine where the communications module 109 consists of a modem or network interface/adapter without any device for manual input/output from/to a user. Furthermore, one of ordinary skill in the art will appreciate that the steps illustrated in the illustrative figures may be performed in other than the recited order, and that one or more steps illustrated may be optional in accordance with aspects of the disclosure.

We claim:

1. A computer-implemented method, comprising:
receiving a fund transfer transaction at a computer network, where the fund transfer transaction includes electronic payee information configured to enable identification of a payee of a transfer of funds from a payor's account to the payee, and where the fund transfer transaction does not indicate a delivery mechanism for the transfer of funds;
determining if the payee has an account with the financial institution by at least comparing the electronic payee information to a customer-payee collection stored in memory on the computer network, where the customer-payee collection contains identifiers of customers of the financial institution that are payees;
if a first criteria is satisfied, electronically transferring the funds from the payor's account to the payee's account and associating electronic payor information with the fund transfer transaction to enable the payee to identify the payor, where the first criteria includes whether the payor's account and the payee's account are with the financial institution; and
if the first criteria is not satisfied, selecting an appropriate delivery mechanism configured to receive the fund transfer transaction for processing, and sending the fund transfer transaction to the appropriate delivery mechanism.

2. The method of claim 1, where the appropriate delivery mechanism is at least one of: a third-party intermediary, automated clearing house network, and electronic check service.

3. The method of claim 2, the selecting further comprising:
selecting the appropriate delivery mechanism based on a second criteria, where the second criteria includes whether the payor has designated a preference to send the funds in paper format or in electronic format.

4. The method of claim 3, where the appropriate delivery mechanism is a electronic check service if the preference to send the funds is in paper format.

5. The method of claim 3, where the appropriate delivery mechanism is the automated clearing house network, if the preference to send the funds is in electronic format.

6. The method of claim 3, where the appropriate delivery mechanism is the third-party intermediary if the second criteria is not satisfied.

7. The method of claim 1, where the electronic payor information includes an account number assigned to the payor by the payee.

8. The method of claim 7, further comprising:
electronically sending at least the account number to the payee for the fund transfer transaction.

9. The method of claim 1, where the fund transfer transaction is automatically recurring at a predetermined time interval.

10. The method of claim 1, further comprising:
performing a plurality of regulatory checks, where the plurality of regulatory checks are configured to detect money laundering activity and to comply with rules defined by a plurality of governmental regulations; and
if a regulatory check of the plurality of regulatory checks fails, then aborting the fund transfer transaction and reporting the fund transfer transaction.

11. The method of claim 10, where the plurality of regulatory checks are fewer in number if the first criteria is satisfied.

12. An apparatus comprising:
a processor for executing computer-executable instructions;
a memory storing computer-executable instructions that when executed cause the processor to perform a method comprising:
processing a fund transfer transaction received at a computer network of a financial institution, where the fund transfer transaction does not indicate a delivery mechanism for a transfer of a payor's funds;
determining if a payee of the fund transfer transaction has an account with the financial institution by at least comparing payee information of the fund transfer transaction to a customer-payee collection, where the customer-payee collection contains identifiers of customers of the financial institution that are payees;
if the payor's account and the payee's account are with the financial institution, electronically transferring the funds from the payor's account to the payee's account and associating electronic payor information with the fund transfer transaction; and
if the payor's account and the payee's account are not both with the financial institution, selecting an appropriate delivery mechanism configured to receive the fund transfer transaction, and sending the fund transfer transaction to the appropriate delivery mechanism; and
a communications module for at least receiving and sending fund transfer transactions.

13. The apparatus of claim 12, the selecting further comprising:
selecting the appropriate delivery mechanism based on a second criteria, where the second criteria includes whether the payor has designated a preference to send the funds in paper format or in electronic format, and where the appropriate delivery mechanism is at least one of: a third-party intermediary, automated clearing house network, and electronic check service

14. The apparatus of claim 12, the method further comprising:
electronically sending the electronic payor information to the payee for the fund transfer transaction, where the electronic payor information includes an account number assigned to the payor by the payee.

15. The apparatus of claim 12, the method further comprising:
performing a plurality of regulatory checks, where the plurality of regulatory checks are configured to detect money laundering activity; and
if a regulatory check of the plurality of regulatory checks fails, then aborting the fund transfer transaction and reporting the fund transfer transaction.

16. The apparatus of claim 15, where the plurality of regulatory checks are fewer in number if the payor's account and the payee's account are with the financial institution.

17. A computer-readable medium storing computer-executable instructions that, when executed, cause a processor to perform a method comprising:
processing a fund transfer transaction received at a financial institution, where the fund transfer transaction does not indicate a delivery mechanism for a transfer of a payor's funds;
determining if a payee of the fund transfer transaction has an account with the financial institution by at least comparing payee information of the fund transfer transaction to a customer-payee collection, where the customer-payee collection contains identifiers of customers of the financial institution that are payees;
if the payor's account and the payee's account are with the financial institution, electronically transferring the funds from the payor's account to the payee's account and associating electronic payor information with the fund transfer transaction;
if the payor's account and the payee's account are not both with the financial institution, selecting an appropriate delivery mechanism configured to receive the fund transfer transaction, and sending the fund transfer transaction to the appropriate delivery mechanism;
performing a plurality of regulatory checks on the fund transfer transaction, where the plurality of regulatory checks are configured to detect money laundering activity; and
if a regulatory check of the plurality of regulatory checks fails, then aborting the fund transfer transaction and reporting the fund transfer transaction.

18. The computer-readable medium of claim 17, where the plurality of regulatory checks are fewer in number if the payor's account and the payee's account are with the financial institution.

19. The computer-readable medium of claim 17, the selecting further comprising:
selecting the appropriate delivery mechanism based on a second criteria, where the second criteria includes whether the payor has designated a preference to send the funds in paper format or in electronic format, and where the appropriate delivery mechanism is at least one of: a third-party intermediary, automated clearing house network, and electronic check service.

20. The computer-readable medium of claim 17, where the fund transfer transaction is automatically recurring at a predetermined time interval.
